(19) United States
(12) Patent Application Publication
(10) Pub. No.: US 2013/0343510 A1
(43) Pub. Date: Dec. 26, 2013

(54) METHOD OF RECONSTRUCTING IMAGE FOR POLYCHROMATIC X-RAY TOMOGRAPHY

(71) Applicant: SAMSUNG ELECTRONICS CO., LTD., Suwon-si (KR)

(72) Inventors: Kwang Eun JANG, Busan (KR); Young Hun SUNG, Hwaseong-si (KR); Jae Hak LEE, Yongin-si (KR); Jong Ha LEE, Hwaseong-si (KR)

(21) Appl. No.: 13/926,323

(22) Filed: Jun. 25, 2013

(30) Foreign Application Priority Data
Jun. 25, 2012 (KR) 10-2012-0068187

(51) Int. Cl. G06T 7/00

(52) U.S. Cl. CPC G06T 7/0012
USPC 378/5; 378/4; 382/132

(57) ABSTRACT

Disclosed herein is a method for reconstructing an X-ray image, including selecting an initial value of a reconstruction value of an internal tissue of a target object, inserting the reconstruction value into a first relationship function to calculate simulation data of measurement data which is detected from X-rays which have passed through the target object, inserting the detected measurement data and the calculated simulation data into a first expression and a second expression for respectively determining a first constant and second constant as coefficients of a second relationship function of a relationship between the measurement data and the simulation data, in order to calculate the first constant and the second constant, and inserting the first constant and the second constant into a third relationship function which relates to the first constant and second constant and the reconstruction value in order to update the reconstruction value.

### CROSS-REFERENCE TO RELATED APPLICATION(S)

This application claims priority from Korean Patent Application No. 10-2012-0068187, filed on Jun. 25, 2012 in the Korean Intellectual Property Office, the disclosure of which is incorporated herein by reference in its entirety.

### BACKGROUND

1. Field

Exemplary embodiments relate to a method for reconstructing an image in order to reconstruct internal information which relates to a target object from data acquired from X-rays which have passed through the target object.

2. Description of the Related Art

Tomography refers to a technology for generating images of tissue cross-sections by using information which relates to the tissues, which information is acquired by using data obtained during sectional photography with X-rays.

Conventional X-ray photography generates an image by irradiating X-rays from a specific direction toward a target object, for example, a human body, receiving X-rays which have passed through the target object, and reading data which relates to the transmitted X-rays, and thus, tissues that are densely arranged inside the target object are imaged to overlap with one another. Accordingly, when internal tissues inside the target object are very dense, a tissue which is subject to detection, such as, for example, a lesion, is frequently concealed by other tissues, and thus, it is difficult to precisely examine minute lesions.

However, tomography overcomes the issues of a conventional X-ray photography apparatus or the like by imaging a target object from a plurality of directions, not from a single direction, in order to obtain an image of a cross-section of a target object.

Tomography will now be described. An X-ray generator which generates X-rays and irradiates a target object with the X-rays and a detector which detects X-rays which have passed through the target object are positioned opposite to each other with respect to, as a rotation axis, a cross-section which is subject to the tomography, that is, the cross-section of the target object, and then the cross-section of the target object is imaged while the X-ray generator and the detector are rotated together about the rotation axis. Thus, tissues positioned in the cross-section of the target object are clearly imaged, and other tissues which are not positioned in the cross-section of the target object are not clearly imaged, thereby facilitating recognition of the tissues which are positioned in the cross-section.

By virtue of tomography, it may be possible to achieve a high resolution image. Thus, the tomography has been widely used in medicine. A medical imaging apparatus employing a form of tomography may include, for example, a computed tomography (CT) apparatus, a tomosynthesis apparatus, or the like.

For example, the CT apparatus refers to a tomography apparatus which is configured to acquire an image of a cross section of a human body by a rotated X-ray generator and a detector. With regard to a method for imaging the cross-section of the human body using the CT apparatus, the rotated X-ray generator irradiates the human body with X-rays and then the detector measures the amount of X-rays, some of which are absorbed by the human body, which have passed through the human body, for example, on an individual photon basis. For example, various organs inside the human body have different densities, and thus, absorb X-rays at different rates. Then, an information processing apparatus which is installed in or connected to the CT apparatus calculates densities of parts of the human body by using the measured reduction amount of X-rays so that a structure inside the cross-section of the human body may be constructed to display an image of the structure.

### SUMMARY

Therefore, it is an aspect of one or more exemplary embodiments to provide a method for reconstructing an image of tissues by using data detected by a detector and an X-ray generator.

It is another aspect of one or more exemplary embodiments to provide a further improved method for reconstructing an image using tomography technology for reconstructing an image of tissues which are positioned in a cross-section by using an imaging apparatus which includes an X-ray generator and a detector which are rotated along an imaginary circular arc with respect to each other.

It is a further aspect of one or more exemplary embodiments to provide a method for reconstructing an image, which method may be used to prevent undesirable image artifacts, such as cupping artifacts whereby a central portion of a cross-section of a reconstructed image of the target object is dark, or broad dark bands are generated in relatively close proximity to a part which has a high attenuation value.

It is a further aspect of one or more exemplary embodiments to provide a method for reconstructing an image, which accurately and effectively divides a material in an X-ray imaging apparatus such as a dual energy computed tomography (CT) apparatus by using a plurality of X-ray spectrums, thereby obtaining a clear image.

In accordance with one or more exemplary embodiments, an accurate image of tissues of a cross-section of the target object, for example, actual tissues positioned in a cross-section of a human body, may be reconstructed, thereby increasing inspection, examination, or diagnosis accuracy when a doctor or a diagnostician inspects, examines, or diagnoses an internal part of a target object.

Additional aspects of the exemplary embodiments will be set forth in part in the description which follows and, in part, will be obvious from the description, or may be learned by practice of the exemplary embodiments.

In accordance with one aspect of one or more exemplary embodiments, a method for reconstructing an image by reconstructing information regarding an internal part of a target object from data acquired from X-rays which have passed through the target object is provided.

The method for reconstructing an X-ray image may include selecting an initial value of a reconstruction value of an internal tissue of a target object, inserting the reconstruction value into a first relationship function in order to calculate simulation data which relates to measurement data which is detected from X-rays which have passed through the target object, inserting the detected measurement data into a first expression which is usable for determining a first constant and inserting the calculated simulation data into a second expression which is usable for determining a second constant, each of the first constant and the second constant being a respective coefficient of a second relationship function which relates to the measurement data and the simulation data, using the first expression and the second expression to calculate the first constant and the second constant, and inserting the first constant and the second constant into a third relationship function which relates to all of the first constant and second constant and the reconstruction value, and executing the third relationship function in order to update the reconstruction value.

In particular, the first expression which is usable for determining the first constant gᵢ^{ε}(\hat{p}\hat{pᵢ}) may be expressible as

$${g}_{i}^{ɛ} ( \hat{{p}_{i}} ) = ( {e}_{i}^{2} {ρ}^{′} ( {e}_{i} ) {\sum }_{E}^{ } \hat{{m}_{i}} ( E ) μ ( E ) ,$$

and the second expression which is usable for determining the second constant Hᵢ^{ε}(\hat{p}\hat{pᵢ}) may be expressible as

$${H}_{i}^{ɛ} ( \hat{{p}_{i}} ) = ( {e}_{i}^{3} {ρ}^{″} ( {e}_{i} ) + {e}_{i}^{2} {ρ}^{′} ( {e}_{i} ) ) {\sum }_{E} \hat{{m}_{i}} ( E ) U ( E ) .$$

eᵢ may be expressible as

$${e}_{i} = \frac{{y}_{i}}{\hat{{y}_{i}}}$$

where yᵢ is measurement data and ŷ\hat{yᵢ} is simulation data.

In addition, the first expression which is usable for determining the first constant gᵢ^{ε}(\hat{p}\hat{pᵢ}) may be expressible as

$${g}_{i}^{ɛ} ( \hat{{p}_{i}} ) = - {e}_{i}^{2} {ρ}^{′} ( {e}_{i} ) {\sum }_{E} {s}_{i} ( E ) μ ( E ) ( {e}_{i} + \frac{{β}_{i} ( E )}{{t}_{i} ( E )} ) ,$$

and the second expression which is usable for determining the second constant may be expressible as

$${H}_{i}^{ɛ} ( \hat{{p}_{i}} ) = ( 2 {e}_{i} {ρ}^{′} ( {e}_{i} ) + {e}_{i}^{2} {ρ}^{″} ( {e}_{i} ) {\sum }_{E} \frac{{s}_{i}^{2} ( E ) U ( E )}{{t}_{i} ( E )} ( {e}_{i} + \frac{{β}_{i} ( E )}{{t}_{i} ( E )} ) .$$

In this case, eᵢ may be expressible as

$${e}_{i} = \frac{{z}_{i} + {ɛ}_{i}}{\hat{{z}_{i}} + {ɛ}_{i}} .$$

In addition, the first expression which is usable for determining the first constant gᵢ^{ε}(\hat{p}\hat{pᵢ}) may be expressible as

$${g}_{i}^{ɛ} ( \hat{{p}_{i}} ) = \frac{1}{U} ( {e}_{i} {ρ}^{′} ( {e}_{i} ) {\sum }_{E} \hat{{s}_{i}} ( E ) μ ( E ) ( {e}_{i} - \frac{υ ( E )}{{t}_{i} ( E )} )$$

and the second expression which is usable for determining the second constant Hᵢ^{ε}(\hat{p}\hat{pᵢ}) may be expressible as

$${H}_{i}^{ɛ} ( \hat{{p}_{i}} ) = \frac{1}{U} ( 2 {e}_{i} {ρ}^{′} ( {e}_{i} ) + {e}_{i}^{2} {ρ}^{″} ( {e}_{i} ) ) {\sum }_{E} \frac{{s}_{i}^{2} ( E ) υ ( E )}{{t}_{i} ( E )} ( \frac{υ ( E )}{{t}_{i} ( E )} - {e}_{i} ) ,$$

and eᵢ may be expressible as

$${e}_{i} = \frac{{z}_{i} + {ɛ}_{i}}{\hat{{z}_{i}} + {ɛ}_{i}} .$$

The first relationship function may be expressible as

$$\hat{{y}_{i}} = {\sum }_{E} \hat{{m}_{i}} ( \hat{{p}_{i}} , E ) .$$

In addition, the second relationship function may include a cost function, and the cost function may be expressible as

$${\sum }_{i} {\sum }_{E} {q}_{i} ( {p}_{i} , E ) = {\sum }_{i} ( {c}_{i}^{ɛ} ( {p}_{i} ) + {( \hat{{p}_{i}} )}^{T} ( {p}_{i} - \hat{{p}_{i}} ) + \frac{1}{2} {( {p}_{i} - \hat{{p}_{i}} )}^{T} {H}_{i}^{ɛ} ( \hat{{p}_{i}} ) ( {p}_{i} - \hat{{p}_{i}} ) )$$

where gᵢ^{ε}(\hat{p}\hat{pᵢ}) is a first constant and Hᵢ^{ε}(\hat{p}\hat{pᵢ}) is a second constant.

The third relationship function may be expressible as

$${x}_{j} = \hat{{x}_{j}} - ( {\sum }_{i} {( {a}_{ij} {γ}_{i} {H}_{i}^{ɛ} ( \hat{{p}_{i}} ) )}^{- 1} ( {\sum }_{i} {a}_{ij} {g}_{i}^{ɛ} ( \hat{{p}_{i}} ) )$$

where gᵢ^{ε}(\hat{p}\hat{pᵢ}) is the first constant and Hᵢ^{ε}(\hat{p}\hat{pᵢ}) is the second constant.

The method may further include substituting the updated reconstruction value for the initial value of the reconstruction value and repeating the inserting the reconstruction value, the inserting the measurement data, and the using the first expression and the second expression to calculate the first constant the second constant, the inserting the first constant and the second constant into the third relationship function, and the executing the third relationship function in order to obtain a new updated reconstruction value.

The method may further include secondarily updating the updated reconstruction value by using a total variation regularization.

In this case, the secondarily updating may be performed at least once, in particular, a plurality of times by using a fourth relationship function, and the fourth relationship function may be expressible as

$${x}_{j}^{*} = \hat{{x}_{j}} - ( {\sum }_{i} {( {a}_{i , j} {γ}_{i} {H}_{i}^{ɛ} ( \hat{{l}_{i}} ) )}^{- 1} ( {\sum }_{i} {a}_{i , j} {g}_{i}^{ɛ} ( \hat{{l}_{i}} ) - λ D ( {g}^{( k )} ) )$$

wherein g^{(k+1)}=g^{(k)}+Δ·G(x*), k←(k+1).

In accordance with another aspect of one or more exemplary embodiments, a method for reconstructing an X-ray image includes selecting an initial value of a reconstruction value of an internal tissue of a target object, selecting a subset which contains at least partial data from among all measurement data, calculating a first relationship function in order to derive simulation data which corresponds to the selected subset, inserting at least one measurement datum from among elements of the selected subset into a first expression which is usable for determining a first constant and inserting a subset of the derived simulation data into a second expression which is usable for determining a second constant, each of the first constant and the second constant being a respective coefficient of a second relationship function which relates to the selected subset of measurement data and the derived subset of simulation data, and using the first expression and the second expression to calculate the first constant and the second constant, inserting the first constant and the second constant into a third relationship function which relates to all of the first constant and second constant and the reconstruction value and executing the third relationship function in order to update the reconstruction value, and using the updated reconstruction value in conjunction with at least a second selected subset of measurement data from among all measurement data to obtain a new updated reconstruction value. In this case, the third relationship function may be expressible as

$${x}_{j} = \hat{{x}_{j}} - ( {\sum }_{i ∈ {S}_{s}} {( {a}_{ij} {γ}_{i} {H}_{i}^{ɛ} ( {p}_{i} ) )}^{- 1} ( {\sum }_{i ∈ {S}_{s}} {a}_{ij} {g}_{i}^{ɛ} ( \hat{{p}_{i}} ) ) .$$

### BRIEF DESCRIPTION OF THE DRAWINGS

These and/or other aspects of one or more exemplary embodiments will become apparent and more readily appreciated from the following description of the one or more exemplary embodiments, taken in conjunction with the accompanying drawings of which:

FIG. 1 is a diagram which illustrates an overall structure of an image reconstruction apparatus, according to an exemplary embodiment;

FIG. 2 is a block diagram which illustrates a reconstruction value calculator, according to an exemplary embodiment;

FIG. 3 is a flowchart which illustrates a method for reconstructing an image, according to an exemplary embodiment; and

FIG. 4 is a flowchart which illustrates a method for reconstructing an image, according to another exemplary embodiment.

### DETAILED DESCRIPTION

Exemplary embodiments relate to obtaining information which relates to an internal structure of a target object from a measured value detected by a detector.

In an X-ray photography apparatus for imaging a cross-section of the target object with X-rays, for example, a computed tomography (CT) apparatus or a tomosynthesis apparatus, an X-ray generator of the CT generates X-rays and irradiates the target object with the X-rays, the CT receives X-rays which have passed through the target object in order to acquire data about the X-rays which have passed through the target object, and then the CT apparatus reconstructs an image of a structure of tissues inside the target object from the acquired data.

Hereinafter, to this end, before a description of a method for acquiring information which relates to tissues in a cross-section of a target object, for example, a human body, such as information which relates to the presence or outer appearance of tissues inside the human body, or the like based on the acquired data, a model of data acquired based on cross-sectional structure information at a predetermined location inside the target object will be described.

Measurement data y, which may be acquired or to be acquired with respect to tissues inside the target object in an iₜₕ pixel of the detector may be expressible according to Expression 1 below.

yᵢ=∫sᵢ(ε)exp(− [symbol] φ(x,y,z,ε)dl)dε [Expression 1]

In Expression 1, sᵢ(ε) refers to a spectrum of X-rays which have been irradiated by the X-ray generator, ε refers to energy of the X-rays, and a function φ refers to a function of attenuation characteristics at a location (x,y,z) of the target object.) In addition, [symbol] ᵢ(•)dl refers to a curvilinear integral between the X-ray generator and the iₜₕ pixel of the detector.

In particular, image reconstruction of tissues of a cross-section refers to acquisition of information of φ(x,y,z,ε), that is, the cross-sectional structure information which is obtained by using the measurement data yᵢ measured by the detector. However, in order to obtain the information of φ(x,y,z,ε) by using only the measurement data yᵢ, an integral of X-ray energy and a curvilinear integral of a cross-sectional structure must be simultaneously solved, and thus, it is difficult to substantially obtain φ(x,y,z,ε) via simple calculation only.

In particular, as a method for obtaining φ(x,y,z,ε), a calculation is performed based on an assumption that monochromatic X-rays are emitted. In this case, the integral of the X-ray energy may be omitted, and thus, a structure of Expression 1 may be simplified. However, in reality, energy generated and irradiated by the X-ray generator does not always have a monochromatic wavelength, and in general, has a polychromatic wavelength. Thus, assuming that X-rays have a monochromatic wavelength, if a reconstructed image and actual tissues are compared with each other, many errors are likely to occur, thereby reducing the accuracy of reconstruction.

Thus, according to an exemplary embodiment, in order to more accurately reconstruct a cross-sectional structure, a cost function of a relationship between measurement data yᵢ which is actually measured and simulation data ŷ\hat{yᵢ} which is synthesized using a reconstructed object is defined, and a reconstruction value xⱼ to minimize the cost function is obtained via iterative reconstruction. In particular, as the number of iterative reconstruction is increased, the accuracy of reconstruction is further improved, thereby reducing a corresponding error of the simulation data.

To this end, a process for updating a reconstruction value xⱼ by using a respective difference between the simulation data ŷ\hat{yᵢ} and the corresponding measurement data yᵢ is continuously iterated in order to obtain a final reconstruction value x to minimize the defined cost function C. When the final reconstruction value x is used, the cost function is minimized. Thus, the respective difference between the measurement data yᵢ which is actually measured and the corresponding simulation data ŷ\hat{yᵢ} which is synthesized using the reconstructed object is also minimized, and the measurement data yᵢ and the corresponding simulation data ŷ\hat{yᵢ} are substantially the same. Accordingly, in this case, the final reconstruction value x of the simulation data ŷ\hat{yᵢ} corresponds to information which relates to tissues of an actual target object. The information which relates to the tissues of the target object may be detected through this process, an image may be generated based on the detection result, and the tissues inside the target object may be reconstructed as an image, thereby obtaining substantially a relatively accurate image of the tissues inside the target object.

According to one or more exemplary embodiments, generalized information theoretic discrepancy (GID) is used in order to solve Expression 1 above. GID is expressible according to Expression 2 below.

$$G ( f ( r ) \vert \vert g ( r ) ) = \int f ( r ) ρ ( \frac{f ( r )}{g ( r )} ) d r \\ {arg min}_{v} ρ ( v ) = 1 \qquad [ Expression 2 ]$$

According to GID, a distance between two non-negative functions is defined, and ρ(v) has a minimum when f(r) and g(r) are the same.

According to one or more exemplary embodiments, the cost function is defined by using GID, and then is re-defined in the form of double minimization of two virtual variables. An alternative function which has a decoupling form of an energy integral and a curvilinear integral is obtained via alternating minimization between the two virtual variables on the re-defined cost function. In particular, a reconstruction algorithm which is based on a polychromatic wavelength model is derived by iteratively minimizing the alternative function of the decoupling form, but not by directly minimizing the cost function formed as though two integrals were present.

According to an exemplary embodiment, Expression 3 below may be obtained by applying GID to the measurement data yᵢ which is actually measured and the simulation data ŷ\hat{yᵢ} which is synthesized by using the reconstructed object.

$$G ( {y}_{i} \vert \vert \hat{{y}_{i}} ) = \int {y}_{i} ρ ( \frac{{y}_{i}}{\hat{{y}_{i}}} ) d r \qquad [ Expression 3 ]$$

Minimization of a difference between the measurement data yᵢ which is actually measured and the simulation data ŷ\hat{yᵢ} by comparing the measurement data yᵢ and the simulation data ŷ\hat{yᵢ} is the same as obtaining a minimum of GID. Thus, one or more exemplary embodiments are directed to calculation of Expression 4 below.

$$argmin \sum {y}_{i} ρ ( \frac{{y}_{i}}{\hat{{y}_{i}}} ) \qquad [ Expression 4 ]$$

In order to calculate Expression 4 above, it is assumed that the reconstruction value xⱼ which relates to the tissue inside the target object relates to a jₜₕ voxel of the target object, and the jₜₕ voxel is composed of K materials. The reconstruction value xⱼ is expressible according to Expression 5 below.

xⱼ=[xⱼ⁽¹⁾, . . . ,xⱼ^{(K)}]^{T} [Expression 5]

In Expression 5, xⱼ^{(k)} is a relative density of a kₜₕ material.

When pᵢ^{(k)} is defined as a curvilinear integral between the X-ray generator and the iₜₕ pixel of the detector with respect to compositions of the kₜₕ material, pᵢ^{(k)} is expressible according to Expression 6 below.

$${p}_{i}^{( k )} = {\sum }_{j} {a}_{ij} \cdot {x}_{j}^{( k )} \qquad [ Expression 6 ]$$

In Expression 6, aᵢⱼ refers to an influence of the jₜₕ voxel on the iₜₕ pixel of the detector and is a weight to reflect a restriction, such as, for example, a limit of the pixel interval or a vibration.

In this case, the simulation data ŷ\hat{yᵢ} may be expressible according to Expression 7 below with reference to Expression 1 above.

$$\hat{{y}_{i}} = {\sum }_{E} \hat{{m}_{i}} ( \hat{{p}_{i}} , E ) \\ {m}_{i} ( {p}_{i} , E ) = {s}_{i} ( E ) exp ( - {μ ( E )}^{T} {p}_{i} ) \qquad [ Expression 7 ]$$

In Expression 7, \hat{m}\hat{mᵢ}(\hat{p}\hat{pᵢ},E) is \hat{m}\hat{mᵢ}(\hat{p}\hat{pᵢ},E)=mᵢ(pᵢ,E)|ₚ_{_{i≈}}\tilde{p}\tilde{pᵢ}. In addition, μ(E) is μ(E)=[μ⁽¹⁾(E), . . . , μ^{(K)}(E)]^{T} which denotes an attenuation curve of a Kₜₕ material, and pᵢ is pᵢ=[pᵢ⁽¹⁾, . . . , pᵢ^{(k)}].

In particular, mᵢ(pᵢ, E) refers to a monochromatic wavelength model in an Eₜₕ energy bin, and thus, the sum of mᵢ(pᵢ,E) corresponds to a polychromatic wavelength model.

When the simulation data ŷ\hat{yᵢ} and the measurement data yᵢ are applied to GID, Expression 8 below is obtained.

$${\sum }_{i} G ( {y}_{i} \vert \vert \hat{{y}_{i}} ) = {\sum }_{i} {y}_{i} \cdot ρ ( \frac{{y}_{i}}{\hat{{y}_{i}}} ) \qquad [ Expression 8 ]$$

In order to obtain a minimum of GID, Expression 8 may be re-expressed according to Expression 9 below by using Expression 7 above.

$${\sum }_{i} G ( {y}_{i} \vert \vert \hat{{y}_{i}} ) = {\sum }_{i} {\sum }_{E} {d}_{i} ( {p}_{i} , E ) \cdot ρ ( \frac{{d}_{i} ( {p}_{i} , E )}{{m}_{i} ( {p}_{i} , E )} ) \\ {d}_{i} ( {p}_{i} , E ) = {m}_{i} ( {p}_{i} , E ) \cdot ( \frac{{y}_{i}}{\hat{{y}_{i}}} ) \qquad [ Expression 9 ]$$

In Expression 9 above, dᵢ(pᵢ,E) is a weight which relates to the simulation data ŷ\hat{yᵢ} and the measurement data yᵢ, which is expressible according to Expression 9 above.

As seen from Expression 9, a GID of variables yᵢ and ŷ\hat{yᵢ} which are obtained via an energy integral may be replaced with a GID with respect to virtual variables which is determined according to energy.

In particular, p(□) may be expressed by, for example, a function which is expressible according to Expression 10 or 11 below.

$$\begin{matrix}\begin{matrix}ρ ( v ) = {v}^{α} + ( \frac{α}{β} ) {v}^{- β} & ( α \geq 0 , β > 0 )\end{matrix} & [ Expression 10 ] \\ \begin{matrix}ρ ( v ) = log ( v ) + \frac{1}{β} {v}^{- β} & ( β > 0 )\end{matrix} & [ Expression 11 ]\end{matrix}$$

In order to measure xⱼ so as to minimize Expression 9 above which defines a distance between the measurement data yᵢ and the simulation data ŷ\hat{yᵢ}, alternating minimization, in which mᵢ(pᵢ,E) and dᵢ(pᵢ,E) are assumed to be independent variables and are iteratively updated, is used. In particular, any one variable of mᵢ(pᵢ,E) and dᵢ(pᵢ,E) may be fixed, and xⱼ, which is used to minimize a non-fixed variable, may be measured. However, in this case, dᵢ(pᵢ,E) may be automatically updated according to Expression 8 above, and thus, a method of updating mᵢ(pᵢ,E) when dᵢ(pᵢ,E) is fixed will be considered.

Expression 9 above may be re-written according to Expression 12.

$${\sum }_{i} {\sum }_{E} {c}_{i} ( {p}_{i} , E ; \hat{{p}_{i}} ) = {\sum }_{i} \hat{{d}_{i}} ( \hat{{p}_{i}} , E ) \cdot ρ ( \frac{\hat{{d}_{i}} ( \hat{{p}_{i}} , E )}{{m}_{i} ( {p}_{i} , E )} ) \qquad [ Expression 12 ]$$

In Expression 12,

$${\sum }_{i} {\sum }_{E} {c}_{i} ( {p}_{i} , E ; \hat{{p}_{i}} )$$

is convex with respect to pᵢ in a case of specific ρ(μ). In this case, when

$${\sum }_{i} {\sum }_{E} {c}_{i} ( {p}_{i} , E ; \hat{{p}_{i}} )$$

is minimized with respect to xᵢ, a reduction of GID is always ensured, and

$${\sum }_{i} {\sum }_{E} {c}_{i} ( {p}_{i} , E ; \hat{{p}_{i}} )$$

always converges on a true value even if any initial estimated value is selected. For example, in the case of α,β≧0 in Expression 10 above or β>0 in Expression 11 above, ρ(μ) is inevitably convex.

However, even in Expression 12 above, pᵢ, which contains xᵢ that is subject to detection, is still positioned in an exponential function, and thus, it is difficult to directly detect xᵢ. Thus, in order to further simplify Expression 12 above, Expression 13 is introduced by using a Taylor-series for developing the left side cᵢ(pᵢ,E; \hat{p}\hat{pᵢ}) of Expression 12 with respect to the variable pᵢ.

$${q}_{i} ( {p}_{i} , E ; \hat{{p}_{i}} ) = {c}_{i} ( \hat{{p}_{i}} , E ) + {{g}_{i} ( \hat{{p}_{i}} , E )}^{T} ( {p}_{i} - \hat{{p}_{i}} ) + \frac{1}{2} {( {p}_{i} - \hat{{p}_{i}} )}^{T} {H}_{i} ( \hat{{p}_{i}} , E ) ( {p}_{i} - \hat{{p}_{i}} ) + … \qquad [ Expression 13 ]$$

A quadratic equation of Expression 14 below may be obtained by limiting a degree of Expression 13 to a degree of 2 or less.

$${q}_{i} ( {p}_{i} , E ; \hat{{p}_{i}} ) = {c}_{i} ( \hat{{p}_{i}} , E ) + {{g}_{i} ( \hat{{p}_{i}} , E )}^{T} ( {p}_{i} - \hat{{p}_{i}} ) + \frac{1}{2} {( {p}_{i} - \hat{{p}_{i}} )}^{T} {H}_{i} ( \hat{{p}_{i}} , E ) ( {p}_{i} - \hat{{p}_{i}} ) \qquad [ Expression 14 ]$$

Expression 14 is expressed in the form of a quadratic function, but not in the form of an exponential function, and thus, it may be possible to directly detect the variable pᵢ.

The sum of Expression 13 according to energy and index,

$${\sum }_{i} {\sum }_{E} {q}_{i} ( {p}_{i} , E )$$

may be finally expressed according to Expression 15 below.

$${\sum }_{i} {\sum }_{E} {q}_{i} ( {p}_{i} , E ) = {\sum }_{t} ( \begin{matrix}{c}_{i}^{ɛ} ( {p}_{i} ) + {{g}_{i}^{ɛ} ( \hat{{p}_{i}} )}^{T} ( {p}_{i} - \hat{{p}_{i}} ) + \\ \frac{1}{2} {( {p}_{i} - \hat{{p}_{i}} )}^{T} {H}_{i}^{ɛ} ( \hat{{p}_{i}} ) ( {p}_{i} - \hat{{p}_{i}} )\end{matrix} ) \qquad [ Expression 15 ]$$

In Expression 15, a superscript ε refers to an integral result of energy.

According to Expression 15 above, an energy integral and a curvilinear integral of a trajectory of an X-ray photon may be decoupled, and it may be possible to approach Expression 15 with respect to the variable pᵢ. A process of modifying Expression 15 to approach Expression 15 with respect to xᵢ will be described with reference to Expressions 36 to 38 which will be shown below. First, a calculation of a gᵢ^{ε}(\hat{p}\hat{pᵢ}) first constant and second constant Hᵢ^{ε}(\hat{p}\hat{pᵢ}) of Expression 15 will be described.

The first constant gᵢ^{ε}(\hat{p}\hat{pᵢ}) and second constant Hᵢ^{ε}(\hat{p}\hat{pᵢ}) of Expression 15 may vary with a reconstruction method, based on a type of data to be reconstructed. According to an exemplary embodiment, when the data to be reconstructed is yᵢ and ŷ\hat{yᵢ}, the first constant and the second constant may be expressible according to Expressions 16 and 17 below, respectively.

$$\begin{matrix}{g}_{i}^{ɛ} ( \hat{{p}_{i}} ) = ( {e}_{i}^{2} {ρ}^{′} ( {e}_{i} ) {\sum }_{E} \hat{{m}_{i}} ( E ) μ ( E ) & [ Expression 16 ] \\ {H}_{i}^{ɛ} ( \hat{{p}_{i}} ) = ( {e}_{i}^{3} {ρ}^{″} ( {e}_{i} ) + {e}_{i}^{2} {ρ}^{′} ( {e}_{i} ) ) {\sum }_{E} \hat{{m}_{i}} ( E ) U ( E ) & [ Expression 17 ]\end{matrix}$$

In Expressions 16 and 17, eᵢ is defined as a ratio between the measurement data yᵢ and the simulation data ŷ\hat{yᵢ}, which is expressible according to Expression 18 below.

$${e}_{i} = \frac{{y}_{i}}{{\hat{y}}_{i}} \qquad [ Expression 18 ]$$

Thus, when the measurement data yᵢ and the simulation data ŷ\hat{yᵢ} are provided, the first constant and the second constant may be calculated by using the measurement data yᵢ and the simulation data ŷ\hat{yᵢ}. For reference, Expressions 16 and 17 are derived via a quadratic Taylor series development of Expression 12 above.

According to another exemplary embodiment, the measurement data z, may be expressible according to Expression 19, which uses a negative log-transform.

$${z}_{i} = - log ( {\sum }_{E} {s}_{i} ( E ) exp ( - {μ ( E )}^{T} {p}_{i} ) ) \qquad [ Expression 19 ]$$

With regard to the description of Expressions 16, 17, and 18, when a distance between the measurement yᵢ data and the simulation data ŷ\hat{yᵢ} is calculated, the cost function is calculated by using data to which no separate process is applied. However, such measurement data may be reconstructed according to Expression 19 by using a logarithmic transform. A value obtained via the logarithmic transform of the measurement data yᵢ is zᵢ.

Expression 20 below may be derived by inserting into zᵢ Expression 2 above.

$${\sum }_{i} {z}_{i} \cdot ρ ( \frac{{z}_{i}}{{\hat{z}}_{i}} ) \qquad [ Expression 20 ]$$

As in Expression 20, when zᵢ is used instead of yᵢ, a weight of zᵢ is more linear than yᵢ. As shown in Expression 1 above, yᵢ is proportional to an exponential function of pᵢ. Thus, when the target object does not have a circular shape, yᵢ is remarkably changed, based on a transmittance distance of X-rays. In particular, when the transmittance distance of X-rays is relatively long, an error at a pixel of the detector is negligible as compared with a corresponding error which relates to data having a relatively short transmittance distance, and thus, there is the potential to generate limited angle artifacts where some image information is missing. In the case of zᵢ, this possibility is relatively low.

However, when zᵢ is directly inserted and used, two issues occur. First, zᵢ may have a negative value. Of course, according to yᵢ≦1, zᵢ is always equal to or greater than zero. However, in an actual reconstruction process, a case of xⱼ≦0 may be frequently generated. In this case, even if GID may be defined according to yᵢ≧1, zᵢ inevitably has a negative value, and thus, it may be impossible to define GID. Second, an error in a background area in Expression 20 is negligible. This is because zᵢ inevitably has a value which equal to zero or approximately equal to zero in the background area.

Thus, GID with regard to zᵢ is defined according to Expression 21 below.

$${\sum }_{i} G ( {z}_{i} \vert \vert {\hat{z}}_{i} ) = {\sum }_{i} ( {z}_{i} + {ɛ}_{i} + {B}_{i} ) \cdot ρ ( \frac{{z}_{i} + {ɛ}_{i}}{{\hat{z}}_{i} + {ɛ}_{i}} ) \qquad [ Expression 21 ]$$

In Expression 21, εᵢ is a constant which causes \hat{z}\hat{zᵢ}+εᵢ always to be greater than zero, and Bᵢ is a constant which functions to correct an error weight of the background area. Various methods are used to define these two constants. As an example, these two constants may be defined according to Expression 22 below using properties whereby yᵢ is equal to one or equal to a value which is very close to one in the background area and is much less than one in other areas. Similar other methods may be applied.

Bᵢ=ω_{B,i}·yᵢ^{αβ,i}

εᵢ=ω_{E,i}·yᵢ^{αE,i} [Expression 22]

In order to minimize Expression 21 above, first, the integral of a trajectory and the energy integral are decoupled. A function −log(μ) is convex when μ>0, and thus, an inequality which is expressible according to Expression 23 is satisfied assuming that Σsᵢ(E)=1

$${z}_{i} + {ɛ}_{i} = - log ( {\sum }_{E} {s}_{i} ( E ) exp ( - {μ ( E )}^{T} {p}_{i} ) + {\sum }_{E} {ξ}_{i} ( E ) \leq {\sum }_{E} {s}_{i} ( E ) ( - log ( exp ( - {μ ( E )}^{T} {p}_{i} ) ) ) + {\sum }_{E} {ξ}_{i} ( E ) = {\sum }_{E} ( {s}_{i} ( E ) {μ ( E )}^{T} {p}_{i} + ξ ( E ) ) \qquad [ Expression 23 ]$$

In Expression 23 above, ξᵢ(E) is a non-negative function and satisfies a condition Σξᵢ(E)=εᵢ. In particular, a virtual variable is defined as in Expression 24 below.

t(pᵢ,E)=sᵢ(E)μᵢ(E)^{T}pᵢ+ξᵢ(E) [Expression 24]

As seen from Expression 24, Expression 24 is similar to Expression 7 above. Thus, similarly to mᵢ(pᵢ,E), tᵢ(pᵢ,E) functions as a virtual monochromatic wavelength model which is defined with respect to each E.

According to the present exemplary embodiment, an arbitrary convex function ρ(v) must satisfy ρ(v)>0 when v≧0. ρ(v), which satisfies the condition, can be easily obtained by adding a positive constant to the already known), ρ(v), e.g., as indicated by either of Expression 10 or 11.

Given the inequality of Expression 23 and the condition

$$ρ ( v ) > 0 , {\sum }_{i} G ( {z}_{i} \vert \vert {\hat{z}}_{i} )$$

may be expressible according to Expression 25 below.

$${\sum }_{i} G ( {z}_{i} \vert \vert {\hat{z}}_{i} ) = {\sum }_{i} {\sum }_{E} ( {z}_{i} + {ɛ}_{i} + {B}_{i} ) \cdot ρ ( \frac{{z}_{i} + {ɛ}_{i}}{{\hat{z}}_{i} + {ɛ}_{i}} ) \leq {\sum }_{i} {\sum }_{E} ( ( \frac{{z}_{i} + {ɛ}_{i}}{{\hat{z}}_{i} + {ɛ}_{i}} ) {t}_{i} ( {p}_{i} , E ) + {β}_{i} ( E ) ) ρ ( \frac{{z}_{i} + {ɛ}_{i}}{{\hat{z}}_{i} + {ɛ}_{i}} \cdot \frac{{t}_{i} ( {p}_{i} , E )}{{t}_{i} ( {p}_{i} , E )} ) = {\sum }_{E} ( {f}_{i} ( {p}_{i} , E ) + {β}_{i} ( E ) ) ρ ( \frac{{f}_{i} ( {p}_{i} , E )}{{t}_{i} ( {p}_{i} , E )} ) \qquad [ Expression 25 ]$$

In Equation 25, βᵢ(E) is an arbitrary non-negative function, the marginal sum of which is Bᵢ with respect to E, and fᵢ(pᵢE) is expressible according to

$${f}_{i} ( {p}_{i} , E ) = {t}_{i} ( {p}_{i} , E ) \cdot ( \frac{{z}_{i} + {ɛ}_{i}}{{\hat{z}}_{i} + {ɛ}_{i}} ) .$$

Thus, as seen from Expression 25, the curvilinear integral and the energy integral are decoupled from each other. In addition, it may be seen that fᵢ(pᵢE), which is newly defined, and the aforementioned dᵢ(pᵢ),E) have considerably similar forms. However, fᵢ(pᵢE) and dᵢ(pᵢ,E) are different in that fᵢ(pᵢE) is linear with respect to pᵢ. Thus, the reconstruction method which is derived according to the present exemplary embodiment has a higher convergence speed than a method in which transform is not performed on an image, and thus, the image may be more quickly reconstructed during iterative reconstruction.

A cost function that approximates to

$${\sum }_{i}^{ } G ( {z}_{i} \vert \vert {\hat{z}}_{i} )$$

may be obtained by using the same method as the method for deriving Expressions 12 through 18, as described above. In addition, gᵢ^{ε}(\hat{p}\hat{pᵢ}) and Hᵢ^{ε}(\hat{p}\hat{pᵢ}) may be obtained from the cost function as shown in Expressions 16 and 17 above, which is derived according to Expression 26 below.

$${g}_{i}^{ɛ} ( {\hat{p}}_{i} ) = - {e}_{i}^{2} {ρ}^{′} ( {e}_{i} ) {\sum }_{E} {s}_{i} ( E ) μ ( E ) ( {e}_{i} + \frac{{β}_{i} ( E )}{{t}_{i} ( E )} ) \\ {H}_{i}^{ɛ} ( {\hat{p}}_{i} ) = ( 2 {e}_{i} {ρ}^{′} ( {e}_{i} ) + {e}_{i}^{2} {ρ}^{″} ( {e}_{i} ) {\sum }_{E} \frac{{s}_{i}^{2} ( E ) U ( E )}{{t}_{i} ( E )} ( {e}_{i} + \frac{{β}_{i} ( E )}{{t}_{i} ( E )} ) \qquad [ Expression 26 \}$$

In Expression 26, eᵢ refers to an error ratio in a logarithmic domain, and is expressible according to Expression 27 below.

$${e}_{i} = \frac{{z}_{i} + {ɛ}_{i}}{{\hat{z}}_{i} + {ɛ}_{i}} \qquad [ Expression 27 ]$$

However, in this case, when Expression 10 above is used, a condition α≧0, β≧1 must be satisfied, and when Expression 11 above is used, a condition β≧1 must be satisfied.

As described above, when a logarithmic transform is performed on data, if a transform value zᵢ and simulation data \hat{z}\hat{zᵢ} of the measurement data are provided, the first constant and the second constant may be calculated by using the given transform value zᵢ and simulation data \hat{z}\hat{zᵢ}, similarly as in a case in which a transform is not performed on the data.

According to other exemplary embodiments, measurement data uᵢ may be a transform value of yᵢ Expression 28 below.

$${u}_{i} = 1 + \frac{log ( {y}_{i} )}{U} \geq 0 \\ U > 0 \qquad [ Expression 28 ]$$

As described above, the reconstruction method using a logarithmic transform may apply a linear weight to several mismatches, and as described above, the virtual variable tᵢ(pᵢ,E) is linear to pᵢ and thus, uᵢ converges more quickly. However, in consideration of the reliability of the measurement data, yᵢ may be used as a weight. Measured data of transform tomography corresponds to the number of X-ray photons that reach the detector, and thus, statistical variance inevitably occurs. Thus, it is inevitable that a small value of yᵢ, that is, a greater value of zᵢ contains much noise. Thus, when is yᵢ used as a weight, it is inevitable that an influence of data containing noise is low, and thus, an influence due to noise is lower than the aforementioned logarithmic transform case. Thus, when data is transformed as in Expression 28 above, it may be possible to reconstruct an image at a higher convergence speed while being less affected by noise.

In particular, U is a positive constant, and thus, uᵢ is a positive number in conclusion.

A logarithmic function is a curve function, and thus, Expression 29 below is expressible as follows.

$$1 - \frac{{\hat{z}}_{i}}{U} = \frac{1}{U} ( U - {\hat{z}}_{i} ) \geq \frac{1}{U} ( U - {\sum }_{E} {s}_{i} ( E ) {μ ( E )}^{T} {p}_{i} ) \qquad [ Expression 29 ]$$

In Expression 29, the aforementioned ρ(v) satisfies ρ(v)<0 for [0,vₘₐₓ], where vₘₐₓ is defined as an upper limit and Expression 29 above may be satisfied by adding a negative constant to a the predefined function ρ(v) and a GID function may be derived, for example, as indicated by Expression 30 below, by using Expressions 28 and 29 above.

$${\sum }_{i} {u}_{i} \cdot ρ ( \frac{{u}_{i}}{{\hat{u}}_{i}} ) = \frac{1}{U} {\sum }_{i} ( U - {z}_{i} ) ( \frac{U - {\hat{z}}_{i}}{U - {\hat{z}}_{i}} ) \cdot ρ ( \frac{U - {z}_{i}}{U - {z}_{i}} ) \leq \frac{1}{U} {\sum }_{i} ( \frac{U - {z}_{i}}{U - {z}_{i}} ) ( U - {\sum }_{E} {s}_{i} ( E ) {μ ( E )}^{T} {p}_{i} ) \cdot ρ ( \frac{U - {z}_{i}}{U - {z}_{i}} ) \qquad [ Expression 30 ]$$

In Expression 30, two virtual variables are defined according to Expression 31 below.

$${g}_{i} ( {p}_{i} , E ) = υ ( E ) - {s}_{i} ( E ) {μ ( E )}^{T} {p}_{i} \\ {q}_{i} ( {p}_{i} , E ) = ( \frac{U - {z}_{i}}{U - {\hat{z}}_{i}} ) \cdot {g}_{i} ( {p}_{i} , E ) \qquad [ Expression 31 ]$$

In Expression 31,

$${\sum }_{E} υ ( E ) = U$$

is satisfied. Expression 32 below may be derived using Expressions 30 and 31 above.

$${\sum }_{i} {u}_{i} \cdot ρ ( \frac{{u}_{i}}{{\hat{u}}_{i}} ) \leq {\sum }_{i} {\sum }_{E} {g}_{i} ( {p}_{i} , E ) \cdot ρ ( \frac{{g}_{i} ( {p}_{i} , E )}{{q}_{i} ( {p}_{i} , E )} ) \qquad [ Expression 32 ]$$

As described above, when alternating minimization between the two virtual variables is used, Expression 32 above may also be minimized.

In Expression 32, υ(E) is defined to cause gᵢ^{ε}(\hat{p}\hat{pᵢ}) in Expression 30 to be greater than zero. However, because U, which is the sum of E of υ(E), influences on

$$\frac{{u}_{i}}{{\hat{u}}_{i}} ,$$

convergence speed is reduced in conclusion. Thus, GID is considered as in Expression 33 below.

$$\begin{matrix}{\sum }_{i} {G}_{υ} ( {z}_{i} \vert \vert {\hat{z}}_{i} ) = {\sum }_{i} ( 1 - \frac{{z}_{i} + {ɛ}_{i}}{U} ) \cdot ρ ( \frac{{z}_{i} + {ɛ}_{i}}{{\hat{z}}_{i} + {ɛ}_{i}} ) \\ = \frac{1}{U} {\sum }_{i} ( U - ( {z}_{i} + {ɛ}_{i} ) ) \cdot ρ ( \frac{{z}_{i} + {ɛ}_{i}}{{\hat{z}}_{i} + {ɛ}_{i}} )\end{matrix} \qquad [ Expression 33 ]$$

In particular, when a method used in Expression 30 above is used, an alternative GID with respect to a virtual variable may be derived.

$${\sum }_{i} {G}_{υ} ( {z}_{i} \vert \vert {\hat{z}}_{i} ) \leq \frac{1}{U} {\sum }_{i} {\sum }_{E} ( U ( E ) - {f}_{i} ( {p}_{i} , E ) ) \cdot ρ ( \frac{{f}_{i} ( {p}_{i} , E )}{{t}_{i} ( {p}_{i} , E )} ) \qquad [ Expression 34 ]$$

In Expression 34, alternating minimization between fᵢ(pᵢ,E) and tᵢ(pᵢ,E) is used, and an issue in terms of minimization of Expression 34 may be addressed.

In this case, when υ(E) is defined so as to satisfy υ(E)>fᵢ(pᵢ,E), a condition α≧0,ε≧1 for Expression 10 above is satisfied, and ρ(•) satisfying a condition β≧1 is used in Expression 11 above, convexity is ensured.

In this case, the first constant gᵢ^{ε}(\hat{p}\hat{pᵢ}) and the second constant Hᵢ^{ε}(\hat{p}\hat{pᵢ}) are determined according to Expression 35 below.

$${g}_{i}^{ɛ} ( {\hat{p}}_{i} ) = \frac{1}{U} ( {e}_{i} {ρ}^{′} ( {e}_{i} ) {\sum }_{E} {\hat{s}}_{i} ( E ) μ ( E ) ( {e}_{i} - \frac{υ ( E )}{{t}_{i} ( E )} ) \\ {H}_{i}^{ɛ} ( {\hat{p}}_{i} ) = \frac{1}{U} ( 2 {e}_{i} {ρ}^{′} ( {e}_{i} ) + {e}_{i}^{2} {ρ}^{″} ( {e}_{i} ) ) {\sum }_{E} \frac{{s}_{i}^{2} ( E ) υ ( E )}{{t}_{i} ( E )} ( \frac{υ ( E )}{{t}_{i} ( E )} - {e}_{i} ) \\ {e}_{i} = \frac{{z}_{i} + {ɛ}_{i}}{{\hat{z}}_{i} + {ɛ}_{i}} \qquad [ Expression 35 ]$$

Thus far, three types of reconstruction methods according to a data processing method have been described. With reference to the above description, the three methods are used to minimize the cost function, such as Expression 15 above.

Although eᵢ, gᵢ^{ε}(\hat{p}\hat{pᵢ}), and Hᵢ^{ε}(\hat{p}\hat{pᵢ}) of Expression 15 above are different from one another, eᵢ, gᵢ^{ε}(\hat{p}\hat{pᵢ}), and gᵢ^{ε}(\hat{p}\hat{pᵢ}) are related to an unknown value pᵢ, and thus, an issue in terms of minimization may be addressed by using the same method.

In Expression 15 above, qᵢ^{ε}(yᵢ; \hat{p}\hat{pᵢ}) is a quadratic function with respect to pᵢ, and thus, is convex. Thus, given conditions

$${\sum }_{i} {α}_{ij} = 1$$

$$and$$

$${α}_{ij} \geq 0 ,$$

an inequality, as indicated in Expression 36 below, is satisfied.

$${\sum }_{i} {q}_{i}^{ɛ} ( {p}_{i} \text{;} {\hat{p}}_{i} ) \leq {\sum }_{ij} {α}_{ij} {q}_{i}^{ɛ} ( \frac{{a}_{ij}}{{α}_{ij}} ( {x}_{j -} {\hat{x}}_{j} ) + {\hat{p}}_{i} \text{;} {\hat{p}}_{i} ) \qquad [ Expression 36 ]$$

In Expression 36, α_{i,j} is defined according to Expression 37 below.

$${α}_{i , j} = \frac{{a}_{i , j}}{{\sum }_{j} {a}_{i , j}} = \frac{{a}_{i , j}}{{γ}_{i}} \qquad [ Expression 37 ]$$

Thus, in order to finally update the reconstruction value, Expression 38 below is obtained.

$${x}_{j} = {\hat{x}}_{j} - ( {\sum }_{i} {( {a}_{ij} {γ}_{i} {H}_{i}^{ɛ} ( {\hat{p}}_{i} ) )}^{- 1} ( {\sum }_{i} {a}_{ij} {g}_{i}^{ɛ} ( {\hat{p}}_{i} ) ) \qquad [ Expression 38 ]$$

In Expression 38, according to an exemplary embodiment, the aforementioned expressions which relate to the first constant gᵢ^{ε}(\hat{p}\hat{pᵢ}) and the second constant Hᵢ^{ε}(\hat{p}\hat{pᵢ}) may be used according to a data transform method.

Expression 38 can be used when only a distance between measurement data and simulation data is to be minimized without regularization. However, in iterative reconstruction, an image may be reconstructed by minimizing regularization together.

Thus, according to an exemplary embodiment, it may be possible to minimize regulation. As an example, total variation regularization (hereinafter, referred to as TV regularization) may be used. In this case, Expression 38 above may further include a subiteration, in accordance with the expression shown in Expression 39 below.

$${x}_{j}^{*} = {\hat{x}}_{j} - ( {\sum }_{i} {( {a}_{i , j} {γ}_{i} {H}_{i}^{ɛ} ( {\hat{l}}_{i} ) )}^{- 1} ( {\sum }_{i} {a}_{i , j} {g}_{i}^{ɛ} ( {\hat{l}}_{i} ) - λ D ( {g}^{( k )} ) ) \\ {g}^{( k + 1 )} = {g}^{( k )} + Δ \cdot G ( {x}^{*} ) , k ← ( k + 1 ) \qquad [ Expression 39 ]$$

(Expression 39 is iterated from k=1.)

In Expression 39 above, D is a divergence operator which is expressible according to Expression 40 below.

D(gₓ,g_{y},g_{z})[i,j,k]=(gₓ[i,j,k]−gₓ[i−1,j,k])+(g_{y}[i,j,k]−g_{y}[i,j−1,k])+(g_{z}[i,j,k]−g_{z}[i,j,k−1] [Expression 40]

A gradient operator that functions as an adjoint operator of a divergence process is expressible according to Expression 41 below.

[gₓ,g_{y},g_{z}]=G(x)

gₓ[i,j,k]=x[i,j,k]−x[i+1,j,k]

g_{y}[i,j,k]=y[i,j,k]−y[i,j+1,k]

g_{z}[i,j,k]=z[i,j,k]−z[i,j,k+1] [Expression 41]

In addition, according to an exemplary embodiment, it may be possible to use an ordered subset method of dividing data into subsets to increase an update number without using the total data once in order to accelerate reconstruction speed. First, when one of S subsets is Mₛ, Expression 38 above may be re-written as Expression 42 below.

$${x}_{j} = {\hat{x}}_{j} - ( {\sum }_{i ε {S}_{s}} {( {a}_{ij} {γ}_{i} {H}_{i}^{ɛ} ( {\hat{p}}_{i} ) )}^{- 1} ( {\sum }_{i ε {S}_{s}} {a}_{ij} {g}_{i}^{ɛ} ( {\hat{p}}_{i} ) ) \qquad [ Expression 42 ]$$

Expression 42 above is iterated from when s is equal to one, in order to perform the subiteration.

According to an exemplary embodiment, when the TV regularization and the ordered subset are simultaneously used, Expressions 39 and 42 above may be combined and used. However, in this case, regularization is necessarily performed based on the number of elements of the subsets. Thus, when the number of elements of the sₜₕ subset Mₛ is Nₛ an expression for update may be expressible according to Expression 43 below.

$${x}_{j}^{*} = {\hat{x}}_{j} - ( {\sum }_{i ε {S}_{s}} {( {a}_{i , j} {γ}_{i} {H}_{i}^{ɛ} ( {\hat{l}}_{i} ) )}^{- 1} ( {\sum }_{i ε {S}_{s}} {a}_{i , j} {g}_{i}^{ɛ} ( {\hat{l}}_{i} ) - \frac{{N}_{s}}{S} λ D ( {g}^{( k )} ) ) \\ {g}^{( k + 1 )} = {g}^{( k )} + Δ \cdot G ( {x}^{*} ) , k ← ( k + 1 ) \qquad [ Expression 43 ]$$

Expression 43 is iterated from when k is equal to one, in order to perform the subiteration.

In this case, subiteration is necessary for the TV regularization for each subset. Thus, excellent image reconstruction is ensured. However, sometimes, a corresponding calculation speed may be reduced. Thus, according to an exemplary embodiment, the ordered subset and the TV regularization may be combined as indicated in Expression 44 or Expression 45 below as necessary.

$${x}_{j}^{*} = {\hat{x}}_{j} - {( {\sum }_{i ε {S}_{s}} {a}_{i , j} {γ}_{i} {H}_{i}^{ɛ} ( {\hat{l}}_{i} ) )}^{- 1} ( {\sum }_{i ε {S}_{s}} {a}_{i , j} {g}_{i}^{ɛ} ( {\hat{l}}_{i} ) ) \\ {g}^{( k + 1 )} = {g}^{( k )} + Δ \cdot G ( {x}^{*} ) , k ← ( k + 1 ) \qquad [ Expression 44 ]$$

Expression 44 is iterated from when s is equal to one.

$${x}_{j}^{**} = {\hat{x}}_{j} - {\hat{x}}_{j}^{*} + {λ ( {\sum }_{i} {a}_{i , j} {γ}_{i} {H}_{i}^{ɛ} ( {\hat{l}}_{i} ) )}^{- 1} D ( {g}^{( k )} ) \\ {g}^{( k + 1 )} = {g}^{( k )} + Δ \cdot G ( {x}^{**} ) , k ← ( k + 1 ) \qquad [ Expression 45 ]$$

Expression 45 is iterated in the range of K from when k is equal to one.

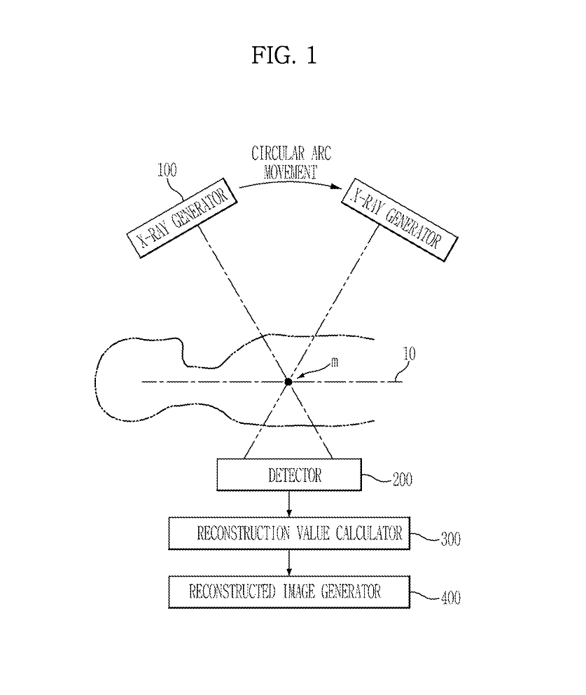

Hereinafter, an example in which an exemplary embodiment is applied to CT imaging will be described with reference to FIGS. 1, 2, 3, and 4.

First, a method for reconstructing an image will be described with regard to an exemplary embodiment.

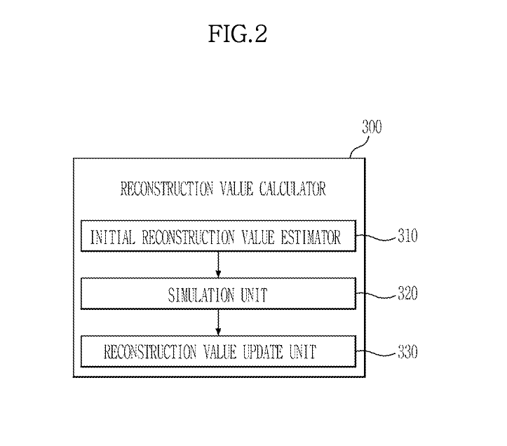

FIG. 1 is a diagram of an overall structure of an image reconstruction apparatus according to an exemplary embodiment, and FIG. 2 is a block diagram of a reconstruction value calculator 300 according to an exemplary embodiment.

As shown in FIG. 1, the image reconstruction apparatus includes an X-ray generator 100 that is rotated about a target object, such as, for example, a human body, with respect to, as a rotation axis, a specific point inside a target object, for example, a cross-section of the target object, and a detector 200 which detects X-rays that are irradiated by the X-ray generator and pass through the target object.

The X-ray generator 100 may emit and irradiate X-rays of an energy spectrum which corresponds to a predetermined voltage applied to the X-ray generator 100. Then, the irradiated X-rays pass through the target object. In this case, the X-rays are entirely absorbed or transmitted or partially absorbed or transmitted based on densities of tissues inside the target object, such as, for example, densities of various organs inside a human body. The propagating X-rays are received by the detector 200. The detector 200 includes a scintillator, a photo diode, or the like. The scintillator generates a flash of light to discharge photons based on the transmitted X-rays, and then, the photo diode receives the discharged photons and converts the photons into an electrical signal. Thus, the X-rays which have passed through the target object are converted into the electrical signal and are stored. Then, the X-rays which have been converted into the electrical signal are measured in order to separately process an image. In this case, the reconstruction value calculator 300 reconstructs the image from measurement data which is acquired from the electrical signal.

As shown in FIG. 1, the image reconstruction apparatus may include the reconstruction value calculator 300.

The reconstruction value calculator 300 performs a function of reconstructing an image. According to an exemplary embodiment, the reconstruction value calculator 300 may include an initial reconstruction value estimator 310 which initializes a reconstruction value for performing the reconstruction, as shown in FIG. 2. The initial reconstruction value estimator 310 performs initialization of the reconstruction value for reconstruction.

In addition, the reconstruction value calculator 300 may further include a simulation unit 320. The simulation unit 320 may be embodied, for example, as a hardware component which includes a processor and/or integrated circuitry and/or other suitable hardware elements.

The simulation unit 320 generates simulation data by using the measurement data which is acquired by measuring the X-rays which have passed through the target object and by using the initialized reconstruction value. In particular, according to an exemplary embodiment, Expression 6 or Expression 7 above may be used. The simulation unit 320 may calculate each of the aforementioned first constant and second constant by using the simulation data. In particular, as an example, the first constant may be expressible according to Expression 16 above and the second constant may be expressible according to Expression 17 above. In addition, according to another exemplary embodiment, the first constant and the second constant may be calculated according to Expressions 26 and 35 above.

In addition, the reconstruction value calculator 300 further includes a reconstruction value update unit 330. The reconstruction value update unit 330 may be embodied, for example, as a hardware component which includes a processor and/or integrated circuitry and/or other suitable hardware elements

The reconstruction value update unit 330 may update the reconstruction value by using the first constant and the second constant. According to an exemplary embodiment, in order to update the reconstruction value, Expression 38 above may be used.

As described above, the reconstruction value calculator 300 initializes the reconstruction value, calculates at least one constant required to update the reconstruction value, and finally calculates the reconstruction value by using the at least one constant.

As shown in FIG. 1, the image reconstruction apparatus according to the present exemplary embodiment may include a reconstructed image generator 400.

The reconstructed image generator 400 may generate a reconstructed image by using the reconstruction value obtained by the reconstruction value calculator 300, and may transmit the reconstructed image to a display device such that a user, such as, for example, a doctor or a patient, may check or examine an image of a cross-section of the target object.

Hereinafter, a method for reconstructing an image will be described with regard to an exemplary embodiment.

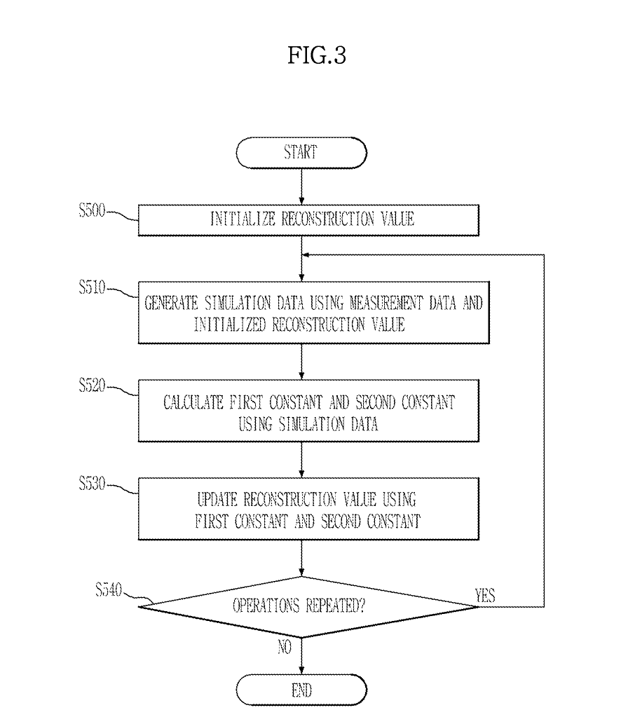

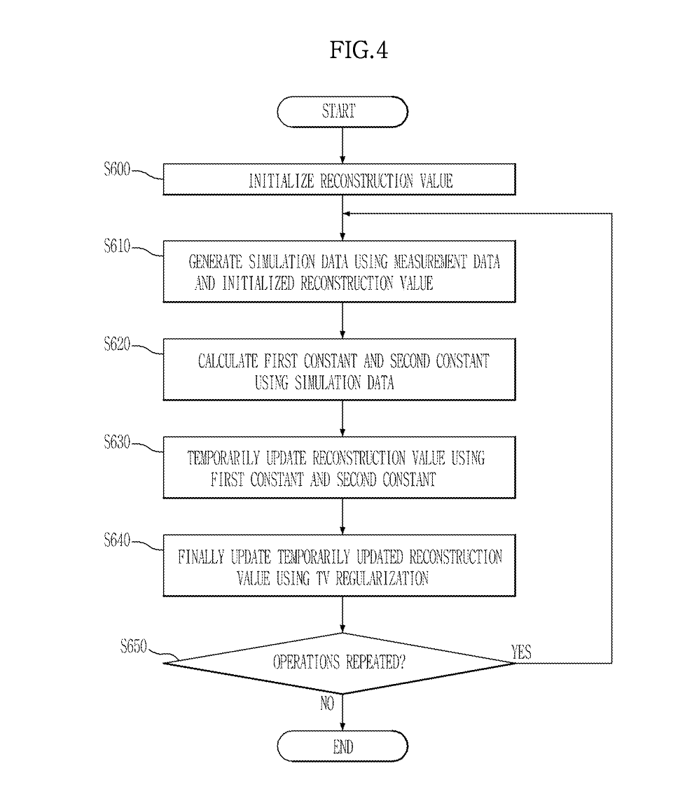

FIG. 3 is a flowchart which illustrates a method for reconstructing an image according to an exemplary embodiment, and FIG. 4 is a flowchart which illustrates a method for reconstructing an image according to another exemplary embodiment.

According to an exemplary embodiment, as shown in FIG. 3, first, a reconstruction value \hat{x}\hat{xᵢ} is initialized in operation S500.

Then, in operation S510, simulation data is calculated by using measurement data yᵢ and the initialized reconstruction value \hat{x}\hat{xᵢ}.

The measurement data is data which is obtained from X-rays which are continuously irradiated by the rotated X-ray generator 100 at various angles, passed through the target object, and detected by the detector 200.

According to an exemplary embodiment, in operation S510, the simulation data may be obtained by using one or both of Expressions 6 and 7 above. In particular, curvilinear integral values of densities in a specific voxel are summed in order to obtain the simulation data ŷ\hat{yᵢ}.

In addition, the measurement data yᵢ and the simulation data ŷ\hat{yᵢ} are inserted into, for example, Expressions 16 and 17 above to respectively obtain the first constant and the second constant in operation S520. Of course, according to an exemplary embodiment, the first constant and the second constant may be obtained by using Expressions 26 and 35 above. Reconstruction speed, presence of errors, and other factors which relate to image reconstruction may vary according to which expressions are used, as described above.

According to an exemplary embodiment, when the first constant and the second constant are determined, in operation S530, the reconstruction value is updated by using Expression 38 above.

Then, according to whether operations S510, S520, and S530 above are repeated, when operations S510, S520, and S530 are not repeated, the updated reconstruction value is considered as the final reconstruction value, and an image is reconstructed based on the final reconstruction value. A determination as to whether to repeat these operations is made in operation S540.

When operations S510, S520, and S530 are repeated, the updated reconstruction value is used as the initialized reconstruction value, as described above, and then, operations S510, S520, and S530 above are repeated by using the most recently updated reconstruction value.

According to an exemplary embodiment, it may be possible to divide data into subsets, such as, for example, a subset which includes several pixels selected by the detector, and to update the reconstruction value based on the selected subset, but not to simultaneously use all data required for image reconstruction, for example, the measurement data acquired from all pixels. In particular, it may be possible to perform the image reconstruction by using an ordered subset method, as described above in detail.

According to another exemplary embodiment, referring to FIG. 4, in operation S600, the reconstruction value may be initialized, and then, in operation S610, the simulation data may be calculated by using the initialized reconstruction value and the measurement data. Then, in operation S620, the first constant and the second constant are calculated by using the simulation data and the measurement data, and in operation S630, the reconstruction value is updated by using the first constant and the second constant. A detailed description of each operation is the same as described above with respect to FIG. 3. However, the updated reconstruction value of FIG. 4 is temporarily updated.

Likewise, the reconstruction value is temporarily updated, and then, in operation S640, the temporarily updated reconstruction value is updated again by using the aforementioned TV regularization to obtain the final reconstruction value xᵢ.

In addition, according to whether operations S610, S620, S630, and S640 above are repeated, the final reconstruction value xᵢ may be used as a reconstruction value for performing image reconstruction, and operations S610, S620, S630, and S640 may be repeated to further update the reconstruction value. A determination as to whether to repeat these operations is made in operation S650. During the repetition, the initialized reconstruction value used in operation S610 is replaced with the most recently determined final reconstruction value xᵢ, which is obtained in operation S640.

The exemplary embodiments relate to a method and an apparatus for reconstructing an image. According to the exemplary embodiments, it may be possible to reconstruct an image whereby an accurate Hounsfield unit (HU) value in CT is reconstructed, and it may be possible to reconstruct an image in which beam hardening artifacts have been avoided. In addition, it may be possible to reconstruct an image without beam hardening artifacts also in tomosynthesis, and it may be possible to reconstruct an accurate image even in an environment in which different X-ray spectrums are used in respective views, such as, for example, a case in which different kilovolt peaks (kVps) are used in respective views. In addition, when a dual energy CT apparatus uses fast switching kV, measurement data regarding all spectrums based on data, some of which is generated and discarded while a voltage (kV) is varied in image construction, can be used for an image reconstruction. Thus, it is possible to reconstruct an accurate image. Moreover, in the dual energy CT apparatus which uses fast switching kV and the dual energy CT apparatus which includes a plurality of X-ray generators, two spectrum data are not acquired from imaging at the same position, and thus, it may not be possible to accurately divide a material. However, according to the exemplary embodiments, dual energy data need not be measured at the same position, and thus, it may be possible to accurately divide a material.

As is apparent from the above description, a method for reconstructing an image and an X-ray imaging apparatus using the same may reconstruct an image of tissues inside a target object by using data detected from a detector and an X-ray generator, and in detail, may reconstruct an accurate image which is virtually identical to the actual tissues, even in a case of polychromatic X-rays.

In addition, a material may be accurately and effectively divided in an X-ray imaging apparatus, such as, for example, a dual energy CT apparatus, by using a plurality of X-ray spectrums, and image artifacts may also be prevented, thereby increasing the clarity and accuracy of a reconstructed image.

Thus, a method for reconstructing an image by using tomography may be improved, and thus, an accurate image of tissues which are positioned in a cross-section of the target object may be reconstructed by using the tomography, thereby increasing inspection, examination, and/or diagnosis accuracy.

Although a few exemplary embodiments have been shown and described, it will be appreciated by those skilled in the art that changes may be made in these exemplary embodiments without departing from the principles and spirit of the present inventive concept, the scope of which is defined in the claims and their equivalents.

What is claimed is:

1. A method for reconstructing an X-ray image, the method comprising:
selecting an initial value of a reconstruction value of an internal tissue of a target object;
inserting the reconstruction value into a first relationship function in order to calculate simulation data which relates to measurement data which is detected from X-rays which have passed through the target object;
inserting the detected measurement data and the calculated simulation data into a first expression which is usable for determining a first constant and a second expression which is usable for determining a second constant, each of the first constant and the second constant being a respective coefficient of a second relationship function regarding the relation between the measurement data and the simulation data, and using the first expression and the second expression to calculate the first constant and the second constant; and
inserting the first constant and the second constant into a third relationship function which relates to all of the first constant and second constant and the reconstruction value, and executing the third relationship function in order to update the reconstruction value.

2. The method according to claim 1, wherein:
the first expression which is usable for determining the first constant gᵢ^{ε}(\hat{p}\hat{pᵢ}) is expressible as
$${g}_{i}^{ɛ} ( {\hat{p}}_{i} ) = ( {e}_{i}^{2} {ρ}^{′} ( {e}_{i} ) {\sum }_{E} {\hat{m}}_{i} ( E ) μ ( E ) ,$$
and the second expression which is usable for determining the second constant Hᵢ^{ε}(\hat{p}\hat{pᵢ}) expressible as
$${H}_{i}^{ɛ} ( {\hat{p}}_{i} ) = ( {e}_{i}^{3} {ρ}^{″} ( {e}_{i} ) + {e}_{i}^{2} {ρ}^{′} ( {e}_{i} ) ) {\sum }_{E}^{ } \hat{{m}_{i}} ( E ) U ( E ) ;$$
wherein:
pᵢ satisfies pᵢ=[pᵢ⁽¹⁾, . . . , pᵢ^{(k)}] and
$${p}_{i}^{( k )} = {\sum }_{j}^{ } {a}_{ij} \cdot {x}_{j}^{( k )}$$
refers to a curvilinear integral which relates to an X-ray generator and an iₜₕ pixel of a detector;
xⱼ^{(k)} is a relative density of a kₜₕ material;
aᵢⱼ refers to an influence of a jₜₕ voxel on an iₜₕ pixel of the detector and is a weight which reflects a restriction relating to at least one of a limit of a pixel interval and a vibration;
eᵢ is expressible as
$${e}_{i} = \frac{{y}_{i}}{\hat{{y}_{i}}}$$
where yᵢ is measurement data and ŷ\hat{yᵢ} is simulation data;
\hat{m}\hat{mᵢ}(E) is a function to which a simulation value of mᵢ(E) is applied, satisfies mᵢ(pᵢ,E)=sᵢ(E)exp(−μ(E)^{T}pᵢ), and is a function of a monochromatic wavelength model in Eth energy bin;
$${\sum }_{E}^{ } {m}_{i} ( {p}_{i ,} E )$$
is a function of a polychromatic wavelength model; and
ρ(v) is determined based on an arbitrary convex function which satisfies
$${argmin}_{v} ρ ( v ) = 1.$$

3. The method according to claim 1, wherein:
the first expression which is usable for determining the first constant gᵢ^{ε}(\hat{p}\hat{pᵢ}) is expressible as
$${g}_{i}^{ɛ} ( \hat{{p}_{i}} ) = - {e}_{i}^{2} {ρ}^{′} ( {e}_{i} ) {\sum }_{E}^{ } {s}_{i} ( E ) μ ( E ) ( {e}_{i} + \frac{{β}_{i} ( E )}{{t}_{i} ( E )} ) ;$$
the second expression which is usable for determining the second constant Hᵢ^{ε}(\hat{p}\hat{pᵢ}) is expressible as
$${H}_{i}^{ɛ} ( \hat{{p}_{i}} ) = ( 2 {e}_{i} {ρ}^{′} ( {e}_{i} ) + {e}_{i}^{2} {ρ}^{″} ( {e}_{i} ) {\sum }_{E}^{ } \frac{{s}_{i}^{2} ( E ) U ( E )}{{t}_{i} ( E )} ( {e}_{i} + \frac{{β}_{i} ( E )}{{t}_{i} ( E )} ) ;$$
eᵢ is expressible as
$${e}_{i} = \frac{{z}_{i} + {ɛ}_{i}}{\hat{{z}_{i}} + {ɛ}_{i}} ;$$
t(pᵢ,E)=sᵢ(E)μᵢ(E)^{T}pᵢ+ξᵢ(E) is satisfied; and
βᵢ(E) is determined as an arbitrary non-negative function, wherein β(E) has a marginal sum Bᵢ with respect to E.

4. The method according to claim 1, wherein:
the first expression which is usable for determining the first constant gᵢ^{ε}(\hat{p}\hat{pᵢ}) is expressible as
$${g}_{i}^{ɛ} ( \hat{{p}_{i}} ) = \frac{1}{U} ( {e}_{i} {ρ}^{′} ( {e}_{i} ) {\sum }_{E}^{ } \hat{{s}_{i}} ( E ) μ ( E ) ( {e}_{i} - \frac{υ ( E )}{{t}_{i} ( E )} ) ;$$
the second expression which is usable for determining the second constant Hᵢ^{ε}(\hat{p}\hat{pᵢ}) is expressible as
$${H}_{i}^{ɛ} ( \hat{{p}_{i}} ) - \frac{1}{U} ( 2 {e}_{i} {ρ}^{′} ( {e}_{i} ) + {e}_{i}^{2} {ρ}^{″} ( {e}_{i} ) ) {\sum }_{E}^{ } \frac{{s}_{i}^{2} ( E ) υ ( E )}{{t}_{i} ( E )} ( \frac{υ ( E )}{{t}_{i} ( E )} - {e}_{i} ) ;$$
and
eᵢ is expressible as
$${e}_{i} = \frac{{z}_{i} + {ɛ}_{i}}{\hat{{z}_{i}} + {ɛ}_{i}} .$$

5. The method according to claim 1, wherein the first relationship function is expressible as
$$\hat{{y}_{i}} = {\sum }_{E}^{ } \hat{{m}_{i}} ( \hat{{p}_{i}} , E ) ,$$
where ŷ\hat{yᵢ} is a simulation measurement, \hat{p}\hat{pᵢ} is a curvilinear integral which relates to an X-ray generator and an ith pixel of a detector, E is energy, mᵢ(pᵢ,E)=sᵢ(E)exp(−μ(E)^{T}pᵢ) is satisfied, sᵢ(E) is a spectrum of X-rays, and μ(•) refers to at least one attenuation characteristic of the target object.

6. The method according to claim 1, wherein:
the second relationship function includes a cost function; and
the cost function is expressible as
$${\sum }_{i}^{ } {\sum }_{E}^{ } {q}_{i} ( {p}_{i} , E ) = {\sum }_{t}^{ } ( {c}_{i}^{ɛ} ( {p}_{i} ) + {{g}_{i}^{ɛ} ( \hat{{p}_{i}} )}^{T} ( {p}_{i} - \hat{{p}_{i}} ) + \frac{1}{2} {( {p}_{i} - \hat{{p}_{i}} )}^{T} {H}_{i}^{ɛ} ( \hat{{p}_{i}} ) ( {p}_{i} - \hat{{p}_{i}} ) ) ,$$
wherein
gᵢ^{ε}(\hat{p}\hat{pᵢ}) the first constant and Hᵢ^{ε}(\hat{p}\hat{pᵢ}) is the second constant.

7. The method according to claim 1, wherein:
the third relationship function is expressible as
$${x}_{j} = \hat{{x}_{j}} - ( {\sum }_{i}^{ } {( {a}_{ij} {γ}_{i} {H}_{i}^{ɛ} ( \hat{{p}_{i}} ) )}^{- 1} ( {\sum }_{i}^{ } {a}_{ij} {g}_{i}^{ɛ} ( \hat{{p}_{i}} ) ) ,$$
wherein
gᵢ^{ε}(\hat{p}\hat{pᵢ}) is the first constant and Hᵢ^{ε}(\hat{p}\hat{pᵢ}) is the second constant.

8. The method according to claim 1, further comprising substituting the updated reconstruction value for the initial value of the reconstruction value and repeating the inserting the reconstruction value, the inserting the measurement data, the using the first expression and the second expression to calculate the first constant and the second constant, the inserting the first constant and the second constant into the third relationship function, and the executing the third relationship function in order to obtain a new updated reconstruction value.

9. The method according to claim 1, further comprising secondarily updating the updated reconstruction value by using a total variation regularization.

10. The method according to claim 9, wherein:
the secondarily updating is performed at least once by using a fourth relationship function; and
the fourth relationship function is expressible as
$${x}_{j}^{*} = \hat{{x}_{j}} - ( {\sum }_{i}^{ } {( {a}_{i , j} {γ}_{i} {H}_{i}^{ɛ} ( \hat{{l}_{i}} ) )}^{- 1} ( {\sum }_{i}^{ } {a}_{i , j} {g}_{i}^{ɛ} ( \hat{{l}_{i}} ) - λ D ( {g}^{( k )} ) ) ,$$
wherein g^{(k+1)}=g^{(k)}+Δ·G(x*), k←(k+1) (which are repeated from k=1);
D(gₓ,g_{y},g_{z})[i,j,k]=(g_{x[i,j,k]-g}ₓ[i−1,j,k])+(g_{y}[i,j,k]−g_{y}[i,j−1,k])+(g_{z}[i,j,k]−g_{z}[i,j,k−1]) satisfied; and wherein each of
[gₓ,g_{y},g_{z}]=G(x)
gₓ[i,j,k]=x[i,j,k]−x[i+1,j,k]
g_{y}[i,j,k]=y[i,j,k]−y[i,j+1,k] and
g_{z}[i,j,k]=z[i,j,k]−z[i,j,k+1] are satisfied.

11. A method for reconstructing an X-ray image, the method comprising:
selecting an initial value of a reconstruction value of an internal tissue of a target object;
selecting a subset which contains at least partial data from among all measurement data;
calculating a first relationship function in order to derive simulation data which corresponds to the selected subset;
inserting at least one measurement datum from among elements of the selected subset and a subset of the derived simulation data into a first expression which is usable for determining a first constant and a second expression which is usable for determining a second constant, each of the first constant and the second constant being a respective coefficient of a second relationship function regarding the relation between the selected subset of measurement data and the derived subset of simulation data, and using the first expression and the second expression to calculate the first constant and the second constant;
inserting the first constant and the second constant into a third relationship function which relates to all of the first constant and second constant and the reconstruction value and executing the third relationship function in order to update the reconstruction value; and
using the updated reconstruction value in conjunction with at least a second selected subset of measurement data from among all measurement data to obtain a new updated reconstruction value.

12. The method according to claim 11, wherein the third relationship function is expressible as
$${x}_{j} = \hat{{x}_{j}} - ( {\sum }_{i ∈ {S}_{s}}^{ } {( {a}_{ij} {γ}_{i} {H}_{i}^{ɛ} ( \hat{{p}_{i}} ) )}^{- 1} ( {\sum }_{i ∈ {S}_{s}}^{ } ( {a}_{ij} {g}_{i}^{ɛ} ( \hat{{p}_{i}} ) ) .$$

13. An apparatus for reconstructing an X-ray image, the apparatus comprising:
a detector which is configured to detect X-rays;
a reconstruction value calculator which is configured to: select an initial value of a reconstruction value which relates to an internal tissue of a target object; insert the reconstruction value into a first relationship function in order to calculate simulation data which relates to measurement data which is detected from X-rays which have passed through the target object by the detector; insert the detected measurement data into a first expression which is usable for determining a first constant, insert the calculated simulation data into a second expression which is usable for determining a second constant, each of the first constant and the second constant being a respective coefficient of a second relationship function which relates to the measurement data and the simulation data, and use the first expression and the second expression to calculate the first constant and the second constant; and insert the first constant and the second constant into a third relationship function which relates to all of the first constant and second constant and the reconstruction value, and execute the third relationship function in order to update the reconstruction value; and
an image generator which is configured to use the detected measurement data and the updated reconstruction value to generate an image of the target object.

14. The apparatus according to claim 13, wherein:
the first expression which is usable for determining the first constant gᵢ^{ε}(\hat{p}\hat{pᵢ}) is expressible as
$${g}_{i}^{ɛ} ( {\hat{p}}_{i} ) = ( {e}_{i}^{2} {ρ}^{′} ( {e}_{i} ) {\sum }_{E}^{ } \hat{{m}_{i}} ( E ) μ ( E ) ,$$
and the second expression which is usable for determining the second constant Hᵢ^{ε}(\hat{p}\hat{pᵢ}) is expressible as
$${H}_{i}^{ɛ} ( {\hat{p}}_{i} ) = ( {e}_{i}^{3} {ρ}^{″} ( {e}_{i} ) + {e}_{i}^{2} {ρ}^{′} ( {e}_{i} ) ) {\sum }_{E}^{ } \hat{{m}_{i}} ( E ) U ( E ) ;$$
wherein:
pᵢ satisfies pᵢ=[pᵢ⁽¹⁾, . . . , pᵢ^{(k)}] and
$${p}_{i}^{( k )} = {\sum }_{j}^{ } {a}_{ij} \cdot {x}_{j}^{( k )}$$
refers to a curvilinear integral which relates to an X-ray generator and an iₜₕ pixel of a detector;
xⱼ^{(k)} is a relative density of a kₜₕ material;
aᵢⱼ refers to an influence of a jₜₕ voxel on an iₜₕ pixel of the detector and is a weight which reflects a restriction relating to at least one of a limit of a pixel interval and a vibration;
eᵢ is expressible as
$${e}_{i} = \frac{{y}_{i}}{\hat{{y}_{i}}}$$
where yᵢ is measurement data and ŷ\hat{yᵢ} is simulation data;
\hat{m}\hat{mᵢ}(E) is a function to which a simulation value of mᵢ(E) is applied, satisfies mᵢ(pᵢ,E)=sᵢ(E)exp(−μ(E)^{T}pᵢ) and is a function of a monochromatic wavelength model in Eth energy bin;
$${\sum }_{E}^{ } {m}_{i} ( {p}_{i ,} E )$$
is a function of a polychromatic wavelength model; and
ρ(v) is determined based on an arbitrary convex function which satisfies
$${arg min }_{v} ρ ( v ) = 1.$$

15. The apparatus according to claim 13, wherein:
the first expression which is usable for determining the first constant gᵢ^{ε}(\hat{p}\hat{pᵢ}) is expressible as
$${g}_{i}^{ɛ} ( {\hat{p}}_{i} ) = - {e}_{i}^{2} {ρ}^{′} ( {e}_{i} ) {\sum }_{E}^{ } {s}_{i} ( E ) μ ( E ) ( {e}_{i} + \frac{{β}_{i} ( E )}{{t}_{i} ( E )} ) ;$$
the second expression which is usable for determining the second constant Hᵢ^{ε}(\hat{p}\hat{pᵢ}) is expressible as
$${H}_{i}^{ɛ} ( {\hat{p}}_{i} ) = ( 2 {e}_{i} {ρ}^{′} ( {e}_{i} ) + {e}_{i}^{2} {ρ}^{″} ( {e}_{i} ) {\sum }_{E}^{ } \frac{{s}_{i}^{2} ( E ) U ( E )}{{t}_{i} ( E )} ( {e}_{i} + \frac{{β}_{i} ( E )}{{t}_{i} ( E )} ) ;$$
eᵢ is expressible as
$${e}_{i} = \frac{{z}_{i} + {ɛ}_{i}}{\hat{{z}_{i}} + {ɛ}_{i}} ;$$
t(pᵢ,E)=sᵢ(E)μᵢ(E)^{T}pᵢ+ξᵢ(E) is satisfied; and
βᵢ(E) is determined as an arbitrary non-negative function, wherein βᵢ(E) has a marginal sum Bᵢ with respect to E.

16. The apparatus according to claim 13, wherein:
the first expression which is usable for determining the first constant gᵢ^{ε}(\hat{p}\hat{pᵢ}) is expressible as
$${g}_{i}^{ɛ} ( {\hat{p}}_{i} ) = \frac{1}{U} ( {e}_{i} {ρ}^{′} ( {e}_{i} ) {\sum }_{E}^{ } \hat{{s}_{i}} ( E ) μ ( E ) ( {e}_{i} - \frac{υ ( E )}{{t}_{i} ( E )} ) ;$$
the second expression which is usable for determining the second constant Hᵢ^{ε}(\hat{p}\hat{pᵢ}) is expressible as
$${H}_{i}^{ɛ} ( {\hat{p}}_{i} ) - \frac{1}{U} ( 2 {e}_{i} {ρ}^{′} ( {e}_{i} ) + {e}_{i}^{2} {ρ}^{″} ( {e}_{i} ) ) {\sum }_{E}^{ } \frac{{s}_{i}^{2} ( E ) υ ( E )}{{t}_{i} ( E )} ( \frac{υ ( E )}{{t}_{i} ( E )} - {e}_{i} ) ;$$
and
eᵢ is expressible as
$${e}_{i} = \frac{{z}_{i} + {ɛ}_{i}}{\hat{{z}_{i}} + {ɛ}_{i}} .$$

17. The apparatus according to claim 13, wherein the first relationship function is expressible as
$$\hat{{y}_{i}} = {\sum }_{E}^{ } \hat{{m}_{i}} ( {\hat{p}}_{i} , E ) ,$$
where ŷ\hat{yᵢ} is a simulation measurement, \hat{p}\hat{pᵢ} is a curvilinear integral which relates to an X-ray generator and an ith pixel of a detector, E is energy, mᵢ(pᵢ,E)=sᵢ(E)exp(−μ(E)^{T}pᵢ) is satisfied, sᵢ(E) is a spectrum of X-rays, and μ(•) refers to at least one attenuation characteristic of the target object.

18. The apparatus according to claim 13, wherein:
the second relationship function includes a cost function; and
the cost function is expressible as
$${\sum }_{i}^{ } {\sum }_{E}^{ } {q}_{i} ( {p}_{i} , E ) = {\sum }_{t}^{ } ( {c}_{i}^{ɛ} ( {p}_{i} ) + {{g}_{i}^{ɛ} ( {\hat{p}}_{i} )}^{T} ( {p}_{i} - {\hat{p}}_{i} ) + \frac{1}{2} {( {p}_{i} - {\hat{p}}_{i} )}^{T} {H}_{i}^{ɛ} ( {\hat{p}}_{i} ) ( {p}_{i} - {\hat{p}}_{i} ) ) ,$$
wherein
gᵢ^{ε}(\hat{p}\hat{pᵢ}) the first constant and Hᵢ^{ε}(\hat{p}\hat{pᵢ}) is the second constant.

19. The apparatus according to claim 13, wherein:
the third relationship function is expressible as
$${x}_{j} = {\hat{x}}_{j} - ( {\sum }_{i}^{ } {( {a}_{ij} {γ}_{i} {H}_{i}^{ɛ} ( {\hat{p}}_{i} ) )}^{- 1} ( {\sum }_{i}^{ } {a}_{ij} {g}_{i}^{ɛ} ( {\hat{p}}_{i} ) ) ,$$
wherein
gᵢ^{ε}(\hat{p}\hat{pᵢ}) is the first constant and Hᵢ^{ε}(\hat{p}\hat{pᵢ}) is the second constant.

20. The apparatus according to claim 13, wherein the reconstruction value calculator is further configured to: substitute the updated reconstruction value for the initial value of the reconstruction value; and repeat the inserting the reconstruction value, the inserting the measurement data, the using the first expression and the second expression to calculate the first constant and the second constant, the inserting the first constant and the second constant into the third relationship function, and the executing the third relationship function in order to obtain a new updated reconstruction value.
